(19) United States
(12) Patent Application Publication
(10) Pub. No.: US 2026/0089060 A1
(43) Pub. Date: Mar. 26, 2026

(54) ENERGY ACCOUNTING WITH DATA CENTER INTEGRATION

(71) Applicant: QSecGrid, Inc., New York, NY (US)

(72) Inventors: Gordon R. WINSTON, Katonah, NY (US); John-Philip GALINSKI, Forest Hills, NY (US); Nigel WALKER, Ponteland (GB); Mark THOMPSON, Blyth (GB); Patrick J.D. SANTOS, Kirkland, WA (US)

(21) Appl. No.: 19/274,217

(22) Filed: Jul. 18, 2025

Related U.S. Application Data
(60) Provisional application No. 63/699,116, filed on Sep. 25, 2024.

(51) Int. Cl. H04L 41/0895; H04L 41/0823; H04L 43/08

(52) U.S. Cl. CPC H04L 41/0895; H04L 41/0823; H04L 43/08

(57) ABSTRACT

An energy accounting system for integration of one or more data centers may include a virtualization platform configured to interface with a plurality of server components. The plurality of the server components may be itemized into Integrated Distributed Energy Resources (IDERs). The energy accounting system may further include an Energy Orchestration Module (EOM) communicatively coupled with the virtualization platform. The EOM may be configured to aggregate the IDERs into a Virtual Power Plant (VPP) and may fetch telemetry data associated with the individual ones of the plurality of the server components. The EOM may further be configured to analyze the fetched telemetry data and the fetched workload data and may further generate data analysis products for benefit of energy optimization of the VPP.

### RELATED APPLICATION

This application claims priority to a commonly owned, U.S. Provisional Patent Application No. 63/699,116, filed on Sep. 25, 2024, and titled “Predictive Energy Management”, which is herein incorporated by reference in its entirety.

### TECHNICAL FIELD

Embodiments of the present invention generally relate to managing energies, and more particularly to accounting of energies with data center integration.

### BACKGROUND

Data centers are facilities designed to house computer systems and associated components, such as servers, storage devices, and networking equipment. The data centers serve to enable a storage, processing, and transmission of vast amounts of data required for various applications. The applications include cloud computing, online services, and enterprise operations. Due to continuous demand for computing resources, the data centers operate continuously/round the clock and consume significant amounts of electricity to power the computer systems and the associated components. The rising energy consumption has prompted efforts to explore alternative and/or mitigation strategies.

Existing power management algorithms offer potential for optimizing energy usage, but current data center infrastructures lack control systems that can be necessary to implement the power management algorithms effectively. Some conventional control architectures may not be suitable for fine-grained energy management and/or integration with modern distributed systems.

Some conventional power distribution systems in the data centers may rely on fixed configurations and uniform power buses. While the power distribution systems support a range of power-consuming devices, they may not fully capitalize on device characteristics to achieve optimized energy allocations. Some power distribution systems may lack flexibility to dynamically adjust energy distribution based on varying operational demands and/or to facilitate energy-sharing across interconnected infrastructures.

There is thus a need for more efficient and/or effective accounting of energies with data center integration.

### BRIEF DESCRIPTION OF THE DRAWINGS

Features and advantages of embodiments of the present invention will become apparent upon consideration of the following detailed description of embodiments thereof, especially when taken in conjunction with the accompanying drawings, in which:

FIG. 1 is a block diagram depicting an exemplary computing environment for data center integration, in accordance with at least one embodiment of the present invention.

FIG. 2 is a functional block diagram of an energy management platform, in accordance with at least one embodiment of the present invention.

FIG. 3 is a functional block diagram depicting a correlation of data centers and a virtualization platform, in accordance with at least one embodiment of the present invention.

FIG. 4 is a functional block diagram depicting an energy management system, in accordance with at least one embodiment of the present invention.

FIG. 5 is a flow diagram depicting an example process for mapping Virtual Power Plants (VPPs) to physical data center energy resources, in accordance with at least one embodiment of the present invention.

FIG. 6 is a flow diagram depicting an example process for mapping Virtual Power Plants (VPPs) to virtual data center energy resources, in accordance with at least one embodiment of the present invention.

FIG. 7 is a flow diagram depicting an example process for tokenization, in accordance with at least one embodiment of the present invention.

FIG. 8 is a schematic diagram illustrating aspects of an example computer, in accordance with at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, “includes”, “such as”, “for instance”, and “for example” mean “including but is not limited to”. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

An energy management system for integration of one or more data centers may include at least one virtualization platform configured to interface with a plurality of server components. The individual ones of the interfaced plurality of server components may be itemized into one or more Integrated Distributed Energy Resources (IDERs). The energy management system may further include at least one Energy Orchestration Module (EOM) that may be communicatively coupled with the at least one virtualization platform. The EOM may be configured to aggregate the one or more IDERs into at least one Virtual Power Plant (VPP); fetch telemetry data associated with the individual ones of the plurality of server components; fetch workload data corresponding to individual ones of the aggregated IDERs from the at least one virtualization platform; analyze one or more of the fetched telemetry data and the fetched workload data; and generate one or more data analysis products for energy optimization of the at least one VPP based at least in part on the analysis of the one or more of the fetched telemetry data and the fetched workload data.

A method for energy orchestration in a data center environment may include steps of: interfacing, via at least one virtualization platform, with a plurality of server components. The individual ones of the interfaced server components may be itemized into one or more Integrated Distributed Energy Resources (IDERs); aggregating, by at least one energy orchestration module (EOM), the one or more IDERs into at least one Virtual Power Plant (VPP); fetching telemetry data associated with the individual ones of the plurality of server components via the at least one EOM; fetching workload data corresponding to individual ones of the aggregated IDERs from the at least one virtualization platform via the at least one EOM; analyzing one or more of the fetched telemetry data and the fetched workload data to generate insights into energy utilization; and generating one or more data analysis products for optimizing energy allocation within the at least one VPP based at least in part on the analysis of the one or more of the fetched telemetry data and the fetched workload data.

A non-transitory computer-readable medium (CRM) storing instructions that, when executed by a processor, may cause a computing device to interface, via at least one virtualization platform, with a plurality of server components. The individual ones of the interfaced server components may be itemized into one or more Integrated Distributed Energy Resources (IDERs); aggregate, by at least one Energy Orchestration Module (EOM), the one or more IDERs into at least one Virtual Power Plant (VPP); fetch telemetry data associated with the individual ones of the plurality of server components via the at least one EOM; fetch workload data corresponding to individual ones of the aggregated IDERs from the at least one virtualization platform via the at least one EOM; analyze one or more of the fetched telemetry data and the fetched workload data to generate insights into energy utilization; and generate one or more data analysis products for optimizing energy allocation within the at least one VPP based at least in part on the analysis of the one or more of the fetched telemetry data and the fetched workload data.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein.

The term “automatic” and variations thereof, as used herein, refers to any suitable process or operation done independent of material human input when the process or operation may be performed. However, a process or operation can be automatic, even though performance of the process or operation uses material or immaterial human input, if the input may be received before performance of the process or operation. Human input may be deemed to be material if such input influences how the process or operation will be performed. Human input that consents to the performance of the process or operation may not be deemed to be “material”.

The term “determine” and variations thereof, as used herein, may include any suitable type of methodology, process, operation, and/or technique. Such determinations may include calculations and/or computations.

The term “virtual machines” and variations thereof, as used herein, may be defined as software-based entities that emulate functions of physical computing devices. The virtual machines may operate independently or dependently from the physical computing devices. The virtual machines may be enabled through use of hypervisors or virtualization software.

The term “software container” and variations thereof, as used herein, may be defined as a lightweight, and/or self-contained unit of software. A software container may leverage a host operating system's kernel and/or resources. A software container may implement partial or full virtualization of one or more host system resources without necessarily rising to the level of a full virtual machine.

The term “Integrated Distributed Energy Resources” (IDERs) and variations thereof, as used herein, may be defined as energy generation, storage, and/or consumption units that are interconnected within a distributed energy network and capable of being integrated into a centralized or decentralized energy management system. The IDERs may be characterized by their ability to generate, store, and/or consume energy locally, and their compatibility with communication and control frameworks for real-time monitoring, management, and/or optimization of energy production, storage, and/or consumption within a microgrid or similar energy distribution network.

The term “Virtual Power Plant” and variations thereof, as used herein, may be defined as a virtualized aggregation of distributed energy resources such as renewable generation units, energy storage systems, and/or flexible consumption units, which are collectively managed and operated as a unified entity.

The term “telemetry” and variations thereof, as used herein, may be defined as a process of collecting, transmitting, and/or receiving data from devices or systems for monitoring, analysis, and/or management. Telemetry data may include Key Performance Indicators (KPIs), operational states, energy production metrics, energy optimization metrics, fault conditions, or other operational insights. In the context of IDERs, the telemetry data may serve as an input for real-time energy monitoring, predictive analytics, and/or the generation of energy management recommendations specially within the microgrid or distributed energy environments.

The term “energy optimization metrics” and variations thereof, as used herein, may be defined as benchmarks for evaluating and/or improving energy efficiency, performance, and/or sustainability within the energy management system. Examples of such benchmarks may include energy utilization efficiency (EUE), power usage effectiveness (PUE), renewable energy usage percentage, load balancing efficiency, energy cost per transaction, system reliability index, and/or carbon footprint reduction.

The term “energy-allied activities” and variations thereof, as used herein, may be defined as operations related to energy generation, energy consumption, energy storage, energy trading, energy lending, and so forth. The energy-allied activities may further involve managing energy flows, optimizing resources, validating usage, ensuring regulatory adherence, and so forth.

The term “energy-related transactions” and variations thereof, as used herein, may be defined as exchanges and/or operations involving the transfer or allocation of energy assets, including trading, pricing adjustments, and/or tokenized exchanges within the energy management system.

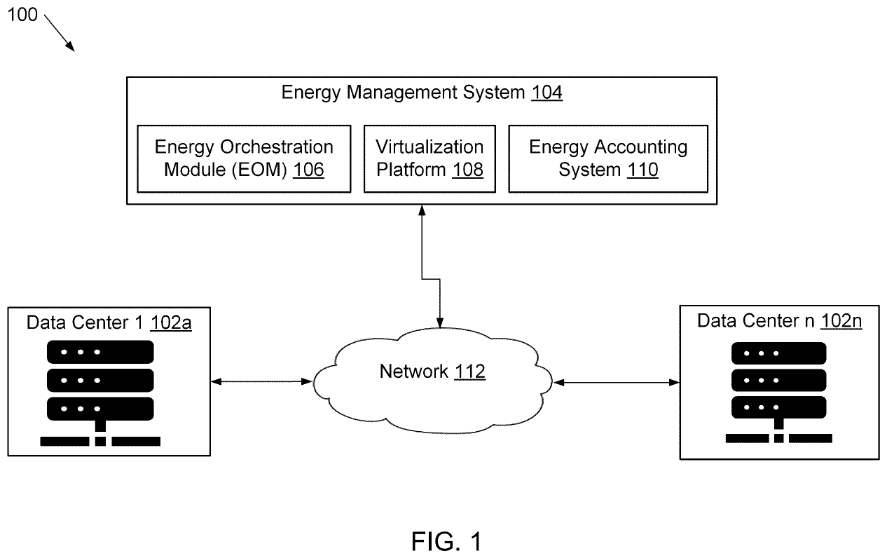

FIG. 1 depicts an exemplary computing environment 100 within a data center environment, according to at least one embodiment of the present invention. The computing environment 100 may include one or more data centers 102a-102n (hereinafter referred to as the data centers 102 or the data center 102). The data center 102 may be a facility or a group of facilities that may be designed to house computing and networking equipment to support the storage, processing, and/or transmission of data.

The data centers 102a-102n may be a geographically distributed facility or a group of geographically distributed facilities across different locations, according to an embodiment of the present invention. The data centers 102a-102n may also be interconnected through high-speed networks for enabling seamless resource sharing, energy load balancing, and/or coordinated operations across facilities, according to another embodiment of the present invention.

The data centers 102 may be configured to house energy-associated machines and/or devices such as a plurality of computing devices, networking equipment, and power management systems to enable the storage, processing, and transmission of data. The data centers 102 may include server components. The server components may be any computing device and/or accessory that may participate in a network 112. The server components may include physical server components and/or virtual server components. Examples of the server components may be physical servers, server blades, storage devices, networking equipment, processor units, memory modules, network interface cards, load balancers, firewalls, cooling systems, power supply units, uninterruptible power supplies, disk arrays, solid-state drives, network switches, routers, virtualization servers, energy management and monitoring devices, environmental monitoring sensors, fiber optic cables, redundant power units, automated racking systems, Power Transaction Units (PTUs), server clusters, and so forth. Embodiments of the present invention may be intended to include or otherwise cover any suitable type of the server components, including known, related art, and/or later developed technologies.

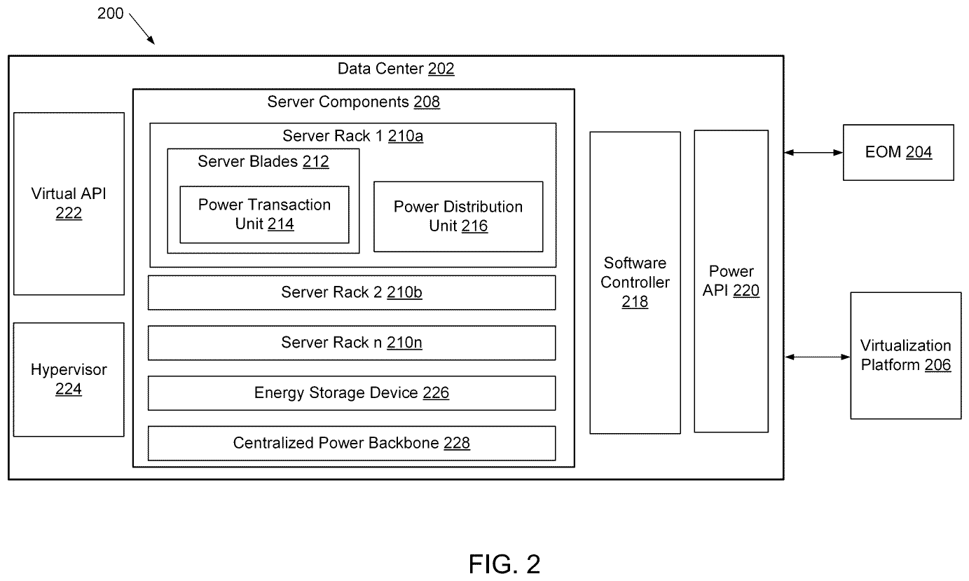

According to the embodiments of the present invention, the server components may be arranged in one or more server racks to optimize space and power distribution within the data center environment. The server components within the data centers 102 may further be configured to form virtualized environments such as virtual machines and software containers, to enhance resource utilization and scalability. In some embodiments of the present invention, the data centers 102 may be configured as microgrids capable of operating independently or in conjunction with external power grids. The configuration may include energy storage devices, such as batteries, which may be utilized for time-shifting energy consumption and/or for providing backup power during peak demand periods. The components of the data center 102 may further be explained in conjunction with FIG. 2.

The computing environment 100 may further include an energy management system 104. The energy management system 104 may be configured to manage energies within the data center environment. The energy management system 104 may further be configured to establish a fine-grained energy management within the one or more data centers 102. The fine-grained energy management may be defined as a detailed and/or precise approach for monitoring, controlling, and optimizing energy usage across systems, devices, and/or facilities. The energy management system 104 may further be configured to enable an abstraction of data center energy resources into IDERS and/or virtual power plants. The energy management system 104 may further be configured to orchestrate power utilization based on the abstraction of data center energy resources.

The energy management system 104 may include non-limiting components such as an Energy Orchestration Module (EOM) 106, a virtualization platform 108, and an energy accounting system 110.

In an embodiment of the present invention, the EOM 106 may be configured to perform the energy management by dynamically aggregating, disaggregating, and allocating the data center energy resources within the data center environment. The EOM 106 may be configured to interface with the energy-associated machines and/or devices, such as server racks, Power Distribution Units (PDUs), and Power Transaction Units (PTUs), as well as virtualized resources, such as virtual machines and software containers. The EOM 106 may utilize telemetry data and workload data of the server components of the data center 102 to optimize energy usage across Integrated Distributed Energy Resources (IDERs) and/or Virtual Power Plants (VPPs). In some embodiments of the present invention, the EOM 106 may leverage artificial intelligence algorithms to generate energy optimization recommendations and may orchestrate energy flow based on the generated energy optimization recommendations.

According to at least one embodiment of the present invention, the virtualization platform 108 may enable creation, aggregation, and/or management of virtualized resources. The virtualized resources may be created by the virtualization platform 108 by enabling an interfacing with the server components of the one or more data centers 102. For instance, the virtualization platform 108 may be configured to interface with the server components that may further be itemized into the IDERs. The itemization of the server components into the IDERs may include defining virtual instances of the server components. For instance, the virtual instances of the server components may include creation and/or representation of the server components, the energy storage devices, and energy assets integrated within the data center environment into the IDERs through the virtualization platform 108.

The virtualization platform 108 may be configured to communicate with the EOM 106 to map the server components to the IDERs and/or the VPPs for benefit of facilitating dynamic energy allocation in the data center environment. The virtualization platform 108 may further be configured to track utilization of some or all of the data center energy resources in the data center environment. In a further embodiment of the present invention, the virtualization platform 108 may be configured to enable disaggregation and/or reaggregation of the server components to enhance scalability, resource efficiency, and/or energy savings in the data center environment.

According to at least one embodiment of the present invention, the energy accounting system 110 may be configured to track, manage, and report energy usage across the data center environment. The energy accounting system 110 may be configured to include functionalities for monitoring the telemetry data from the IDERs, the VPPs, and the server components for enabling accurate energy allocation and reconciliation.

According to at least one embodiment of the present invention, the energy accounting system 110 may further be configured to be compliant with one or more net metering standards. The one or more net metering standards may include energy consumption standards for metered consumption of the energies. The one or more net metering standards may further include guidelines for bidirectional energy flow, measurement of energy exported to and imported from a power grid, settlement mechanisms for energy credits, equitable accounting of energy-related transactions, and so forth. Embodiments of the present invention may be intended to include or otherwise cover any suitable guidelines, including known, related art, and/or later developed technologies.

In an embodiment of the present invention, the energy accounting system 110 may further be configured to manage energy-backed tokens to enable a validation, a trading, and/or secure transactions of the energy assets.

According to at least one embodiment of the present invention, the network 112 may be adapted to establish a telecommunicative network among the data centers 102 and the energy management system 104. The network 112 may be a wired communication network, a wireless communication network, and so forth. Embodiments of the present invention may be intended to include or otherwise cover any suitable type of the network 112, including known, related art, and/or later developed technologies. The wired communication network may be enabled by means such as a twisted pair cable, a co-axial cable, an Ethernet cable, a modem, a router, a switch, and so forth. Embodiments of the present invention may be intended to include or otherwise cover any suitable type of the means that may enable the wired communication network, including known, related art, and/or later developed technologies. The wireless communication network may be enabled by means such as a Wi-Fi communication module, a Bluetooth communication module, a millimeter waves communication module, an Ultra-High Frequency (UHF) communication module, and so forth. Embodiments of the present invention may be intended to include or otherwise cover any suitable type of the means that may enable the wireless communication network, including known, related art, and/or later developed technologies.

FIG. 2 depicts an exemplary functional block diagram of components of an energy management platform 200, in accordance with at least one embodiment of the present invention. The energy management platform 200 may be configured to enable interfacing of a data center 202 with an Energy Orchestration Module (EOM) 204 and/or a virtualization platform 206. The energy management platform 200 may further be configured to facilitate an efficient energy utilization by dynamically monitoring, allocating, and/or optimizing the data center energy resources across interconnected components in the data center environment.

The data center 202 (FIG. 2) may be a further example of the data center 102 (FIG. 1). The EOM 204 (FIG. 2) may be a further example of the EOM 106 (FIG. 1). The virtualization platform 206 (FIG. 2) may be a further example of the virtualization platform 108 (FIG. 1).

According to at least one embodiment of the present invention, the data center 202 may include one or more server components 208. The server components 208 may be arranged on one or more server racks 210a-210n, in an embodiment of the present invention. For instance, a server rack 210a may include the server components 208 such as one or more server blades 212, a Power Transaction Unit (PTU) 214 corresponding to the one or more server blades 212, a Power Distribution Unit (PDU) 216, and so forth. Further, the server rack 210b may include the server components 208 such as the virtual server components and/or the physical server components, in an embodiment of the present invention.

In an embodiment of the present invention, the server components 208 may be populated over the one or more server racks 210a-210n with a different type, model, and iteration of the server components 208. In an additional embodiment of the present invention, the server components 208 may be populated over the one or more server racks 210a-210n with a similar type, model, and iteration of the server components 208. Embodiments of the present invention may be intended to include or otherwise cover any suitable arrangement of the server components 208 on the one or more server racks 210a-210n, including known, related art, and/or later developed technologies.

The server blades 212 may be servers and/or server chips that may be housed in the server racks 210a-210n within the data center 202. The server blades 212 may be a compact version of a conventional server. The server blades 212 may be adapted to save space in the server racks 210a-210n. The server blades 212 may provide efficient computing power while drawing an adequate energy for handling diverse workloads that may be carried out by the server blades 212.

The PTU 214 may be integrated into the one or more server blades 212, and may be configured to manage and/or optimize power usage by the server blades 212 in the data center 202. The PTU 214 may be configured to enable a precise control over power by performing functions such as, a voltage conversion, a conversion of alternating current (AC) to direct current (DC), and so forth. The PTU 214 may further be configured to support software-based modulation of power. The software-based modulation of power by the PTU 214 may enable a software controller 218 to dynamically adjust the energy that may be supplied to the server blades 212. The dynamic adjustment of the energy may be based on real-time requirements of the server blades 212. The PTU 214 may further enhance energy efficiency and reduce wastage of energy. Embodiments of the present invention may be intended to include or otherwise cover any suitable functions of the PTU 214, including known, related art, and/or later developed technologies.

According to at least one embodiment of the present invention, the PDU 216 may be adapted to distribute electrical power to the server components 208 in the server racks 210a-210n. The PDU 216 may receive electrical power from a centralized power backbone 228. Further, the PDU 216 may deliver the received electrical power to the server components 208 at specified voltages, such as 110V, 220V, and so forth. The PDU 216 may include telemetry and remote control capabilities. The telemetry and the remote control capabilities may enable the power distribution using the PDU 216. The power distribution using the PDU 216 may be monitored and managed using the software controller 218.

The data center 202 may further include the software controller 218, a power API 220, a virtual API 222, a hypervisor 224, the centralized power backbone 228, and an energy storage device 226. According to at least one embodiment of the present invention, the software controller 218 may be configured for managing power and energy orchestration in the data center 202. The software controller 218 may be configured to interface with hardware components such as the server blades 212, the PTU 214, and the PDU 216 to enable the monitoring, the modulation, and/or the management of the electrical power. By connecting with software level kernels of the server blades 212, the PTU 214, and the PDU 216, the software controller 218 may adjust power settings dynamically, collect telemetry data, and implement energy-saving strategies.

According to at least one embodiment of the present invention, the power API 220 may be configured to enable the software controller 218 to regularize management of power-related functions. The power API 220 may be configured to facilitate communication between the software controller 218 and the hardware components such as the server blades 212, the PTU 214, and the PDU 216.

According to at least one embodiment of the present invention, the virtual API 222 may be configured to enable the disaggregation and/or management of physical servers into the virtual machines in the data center 202. The virtual API 222 may facilitate communication between the software controller 216 and the hypervisor 224, allowing for operations like creating, configuring, or managing the virtual machines.

According to at least one embodiment of the present invention, the hypervisor 224 may be configured to enable the virtualization of the server components 208 by creating and managing multiple virtual machines that may operate independently on shared hardware. The hypervisor 224 may be configured to abstract the underlying server components 208 may further dynamically allocate resources such as Central Processing Unit (CPU), memory, and storage to each virtual machine. The hypervisor 224 may further be configured to enable an efficient utilization of the physical resources by running multiple workloads on a physical single server while maintaining an isolation between the virtual machines.

According to at least one embodiment of the present invention, the energy storage device 226 may be configured to store electrical energy for real-time use and/or deferred utilization. Examples of the energy storage device 226 may be, batteries, flywheels, capacitors, supercapacitors, ultracapacitors, fuel cells, pumped hydroelectric storage systems, compressed air energy storage systems, thermal energy storage systems, lithium-ion batteries, lead-acid batteries, nickel-metal hydride batteries, sodium-sulfur batteries, redox flow batteries, magnetic energy storage systems, gravitational energy storage systems, mechanical energy storage systems, electrochemical cells, hydrogen storage systems, molten salt storage systems, kinetic energy storage systems, piezoelectric storage systems, and so forth. Embodiments of the present invention may be intended to include or otherwise cover any suitable types of the energy storage device 226, including known, related art, and/or later developed technologies.

The energy storage device 226 may further be adapted to dynamically interact with the EOM 204 to facilitate operations such as power time-shifting, load balancing, grid stabilization, backup energy supply, and so forth. Embodiments of the present invention may be intended to include or otherwise cover any suitable operations using the energy storage device 226, including known, related art, and/or later developed technologies.

According to at least one embodiment of the present invention, the energy storage device 226 may be configured to balance power loads by storing excess energy during low-demand periods and/or supplying the stored excess energy during peak demand or in case of power interruptions in the data center environment. According to an additional embodiment of the present invention, the energy storage device 226 may be configured to be provisioned with renewable energy sources to enable energy management strategies such as load shifting and/or microgrid operation.

According to at least one embodiment of the present invention, the centralized power backbone 228 may be a power distribution system within the data center 202 that may be configured to supply electricity to some or all of the server components 208 and/or all connected devices of the data center 202. The centralized power backbone 228 may operate at a consistent voltage level, such as 110V, 220V, or even higher voltages like 500V or 800V in advanced systems, to minimize power losses during transmission and conversion. The centralized power backbone 228 may further enable a uniform power delivery across the data center 202, supporting efficient energy distribution and reducing operational costs.

In an embodiment of the present invention, the Energy Orchestration Module (EOM) 204, the virtualization platform 206, and components of the data center 202 may be interfaced to enable dynamic energy management in the data center environment. The virtualization platform 206 may be configured to provide the EOM 204 with telemetry data of the data center energy resources, including power consumption and workload metrics, and map virtual machines and software containers to IDERs for precise energy allocation. The EOM 204 may be configured to interface with the software controller 218 to regulate a power supplied by the PTU 214 and PDU 216. The EOM 204 may further dynamically adjust energy distribution based on the workload data of the data center energy resources. The PDU 216, connected to the centralized power backbone 228, may be configured to monitor and/or distribute power to the server components 208, while the energy storage device 226 may store excess energy for peak demand or backup use within the data center environment. The hypervisor 224 may be configured to allocate server resources and/or to provide telemetry data to the virtualization platform 206 to enable efficient energy utilization across the data center 202.

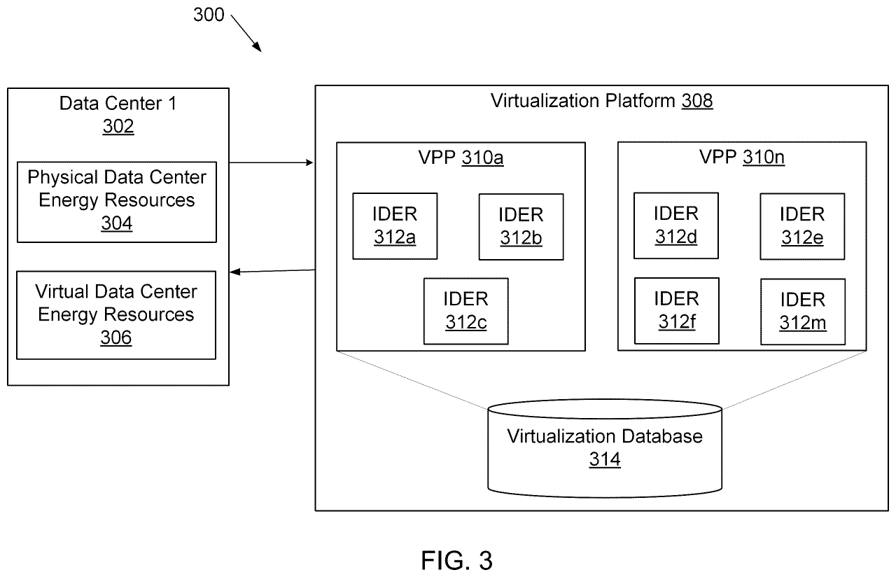

The functionality of the EOM 204, and/or the virtualization platform 206 may further be explained in conjunction with FIG. 3.

FIG. 3 depicts an exemplary functional block diagram of an energy management platform 300. The energy management platform 300 (FIG. 3) may be an example of the energy management platform 200 (FIG. 2). The energy management platform 300 may be configured to enable interaction between a data center 302 and a virtualization platform 308, in accordance with at least one embodiment of the present invention. The data center 302 (FIG. 3) may be an example of the data center 102 (FIG. 1). The virtualization platform 308 (FIG. 3) may be an example of the virtualization platform 108 (FIG. 1).

According to at least one embodiment of the present invention, the data center 302 may include the one or more data center energy resources such as physical data center energy resources 304 and/or virtual data center energy resources 306. Examples of the physical data center energy resources 304 may be the physical server components, computers, laptops, servers, mainframes, firewalls, routers, switches, buses, wireless access points, power transaction units (PTUs), and so forth. Embodiments of the present invention may be intended to include or otherwise cover any suitable type of the physical data center energy resources 304, including known, related art, and/or later developed technologies. Examples of the virtual data center energy resources 306 may be the virtual server components, a sandbox, a virtually established computer, a remote desktop computer, and so forth. Embodiments of the present invention may be intended to include or otherwise cover any suitable type of the virtual data center energy resources 306, including known, related art, and/or later developed technologies.

According to at least one embodiment of the present invention, the virtualization platform 308 may be configured to interface with the physical data center energy resources 304 and/or the virtual data center energy resources 306. In an embodiment of the present invention, the interfaced physical data center energy resources 304 and/or the interface virtual data center energy resources 306 may be itemized into one or more integrated distributed energy resources (IDERs) 312a-312m (hereinafter referred individually to as the IDER 312, and plurally to as the IDERs 312).

In an embodiment of the present invention, the virtualization platform 308 may be configured to create one or more virtual machines, and/or one or more software containers based on the virtual data center energy resources 306 that may be the virtual server components. The created virtual machines and/or the one or more software containers may be mapped with the data center energy resources 306 corresponding to the one or more IDERs 312a-312m. For example, the virtualization platform 308 may be configured to allocate the virtual machines and/or the software containers to specific tasks related to the management and optimization of the data center energy resources. For instance, a virtual machine may be designated to manage energy storage from one or more battery units integrated within the IDERs 312a-312m. The virtualization platform 308 may be configured to dynamically adjust the allocation of the virtual machines and/or the software containers based on the real-time monitoring of energy usage and availability for efficient distribution and/or utilization of the energies across the IDERs 312a-312m.

According to at least one embodiment of the present invention, the one or more IDERs 312a-312m may be aggregated, reaggregated, and/or disaggregated into one or more Virtual Power Plants (VPP) 310a-310n (hereinafter also referred individually to as the VPP 310, and plurally to as the VPPs 310). Such aggregation operations may include collection, partitioning, provisioning, allocation, grouping, and/or clustering operations. In an embodiment of the present invention, the VPPs 310 may be established upon clustering the one or more IDERs 312a-312m into groups of ‘n’. Here ‘n’ may be any natural number. Further, the IDERs 312 may be adapted for generation, storage, and/or consumption of energy units that may be correlated to the physical data center energy resources 304 and the virtual data center energy resources 306 in the data center 302.

According to at least one embodiment of the present invention, the virtualization platform 308 may include a virtualization database 314. The virtualization database 314 may be configured to store the telemetry data and/or the workload data related to data center energy resources. The virtualization database 314 may further be configured to store the mappings to the data center energy resources corresponding to the IDERs 312.

According to embodiments of the present invention, the virtualization database 314 may be for example a cloud database, a distributed database, a personal database, an end-user database, a commercial database, a Structured Query Language (SQL) database, a non-SQL database, an operational database, a relational database, an object-oriented database, a graph database, and so forth. Embodiments of the present invention may be intended to include or otherwise cover any suitable type of the virtualization database 314 including known, related art, and/or later developed technologies.

Further, the virtualization database 314 may be stored in a cloud server, in an embodiment of the present invention. In an embodiment of the present invention, the cloud server may be remotely located. In an embodiment of the present invention, the cloud server may be a public cloud server. In another embodiment of the present invention, the cloud server may be a private cloud server. In yet another embodiment of the present invention, the cloud server may be a dedicated cloud server. According to embodiments of the present invention, the cloud server may be a Microsoft Azure cloud server, an Amazon AWS cloud server, a Google Compute Engine (GCE) cloud server, an Amazon Elastic Compute Cloud (EC2) cloud server, and so forth. Embodiments of the present invention may be intended to include or otherwise cover any suitable type of the cloud server including known, related art, and/or later developed technologies.

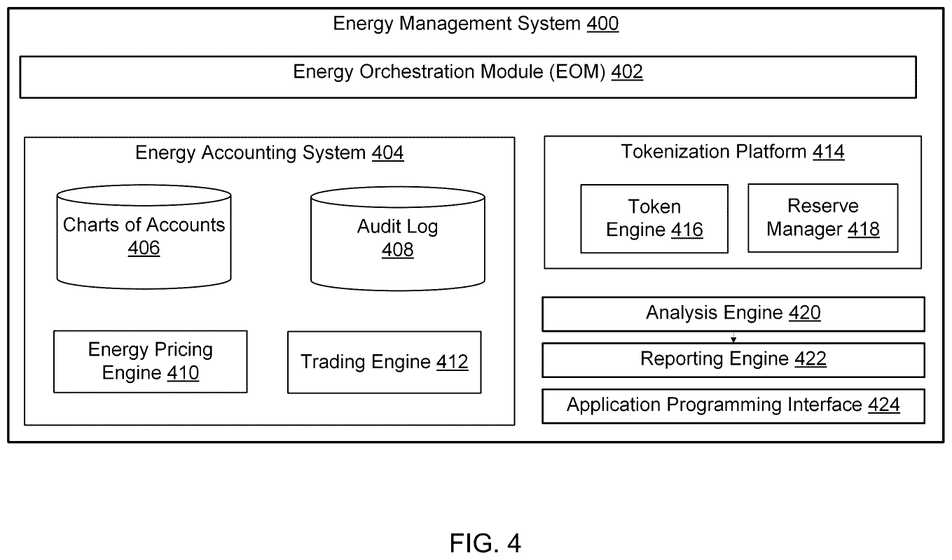

FIG. 4 depicts an exemplary functional block diagram depicting an energy management system 400, in accordance with at least one embodiment of the present invention. The energy management system 400 (FIG. 4) may be a further example of the energy management system 104 (FIG. 1).

According to at least one embodiment of the present invention, the energy management system 400 may be configured to optimize energy usage by dynamically aggregating, disaggregating, and allocating the data center energy resources in real-time. The energy management system 400 may adapted to be integrated with IDERs (e.g., the IDERs 312) and VPPs (e.g., the VPPs 310) to enable an effective and/or an efficient energy distribution across the data center energy resources. The energy management system 400 may be configured to use the telemetry data and analytics to enable the energy management and/or optimization. The energy management system 400 may include an Energy Orchestration Module (EOM) 402. The Energy Orchestration Module (EOM) 402 (FIG. 4) may be a further example of the Energy Orchestration Module (EOM) 106 (FIG. 1).

According to at least one embodiment of the present invention, the EOM 402 may be configured to fetch telemetry data associated with the one or more server components. The telemetry data may include real-time information associated with one or more server components, such as power consumption, CPU utilization, memory usage, thermal output, and so forth. The telemetry data may further include operational metrics derived from hypervisor (e.g., the hypervisor 224) and operating systems of the virtual machines to provide granular insights into workload-specific energy requirements. The telemetry may correspond to individual virtual components and/or allocations, aggregations of virtual components and/or allocations, individual physical components, and/or aggregations of physical components including aggregations above the individual server level. Embodiments of the present invention may be intended to include or otherwise cover any suitable telemetry data associated with one or more server components including known, related art, and/or later developed technologies.

The EOM 402 may be configured to dynamically aggregate, disaggregate, and/or allocate the data center energy resources to the one or more IDERs based on inputs received from a virtualization platform (e.g., the virtualization platform 108). According to at least one embodiment of the present invention, the EOM 402 may be configured to utilize the fetched telemetry data to assess the operational efficiency of the server components. The EOM 402 may also be configured to fetch the workload data corresponding to the aggregated IDERs through the virtualization platform. The workload data may include details regarding task priorities, execution durations, computational demands of the server components, and so forth. Embodiments of the present invention may be intended to include or otherwise cover any suitable workload data associated with one or more server components including known, related art, and/or later developed technologies.

According to an embodiment of the present invention, the EOM 402 may be configured to analyze the fetched telemetry data and/or the fetched workload data to generate one or more data analysis products. The EOM 402 may further be configured to dynamically adjust power allocation to the one or more aggregated IDERs based on the one or more generated data analysis products. According to an embodiment of the present invention, the one or more data analysis products may include, but are not limited to, power consumption trends, workload forecasting reports, energy efficiency metrics, thermal management insights, predictive maintenance alerts, energy allocation recommendations, load balancing strategies, real-time power utilization dashboards, anomaly detection reports, fault diagnostics, demand-response optimization plans, historical power usage comparisons, peak load analysis, energy savings estimates, renewable energy contribution metrics, carbon footprint assessments, system reliability reports, cost optimization strategies, and operational risk assessments. Embodiments of the present invention may be intended to include or otherwise cover any suitable data analysis products, including known, related art, and/or later developed technologies.

For instance, by assessing the operational efficiency of the server components, the EOM 402 may be configured to predict power allocation needs based on workload demands of the server components in the data center environment. This configuration may enable an optimized power management and may further minimize energy wastage across the data center.

The energy management system 400 may further include an energy accounting system 404. The energy accounting system 404 (FIG. 4) may be a further example of the energy accounting system 110 (FIG. 1). The energy accounting system 404 may be configured to track, manage, and/or report energy usage across distributed environments. The energy accounting system 404 may also be configured to work in conjunction with the EOM 402 by utilizing the one or more data analysis products and/or operational insights generated by the EOM 402. By monitoring the telemetry data and supporting compliance with the one or more net metering standards, the energy accounting system 404 may be configured to enhance an accuracy of energy usage, energy tracking, and/or energy related reporting in the data center environment.

The energy accounting system 404 may include non-limiting components such as charts of accounts 406, an audit log 408, an energy pricing engine 410, and a trading engine 412, according to at least one embodiment of the present invention.

According to at least one embodiment of the present invention, the charts of accounts 406 may be configured to organize the energy-related transactions. The charts of accounts 406 may further be configured to allow a detailed tracking and the reconciliation of the energy data corresponding to the one or more IDERs and/or the one or more VPPs. The charts of accounts 406 may be configured to enable plotting of energy-related attributes for reporting, compliance, and/or analytics-related requests in the data center environment.

According to at least one embodiment of the present invention, the audit log 408 may be adapted to record and maintain the mapping of all energy-related transactions. The audit log 408 may be adapted to store detailed entries for energy generation, consumption, and transfer activities, ensuring accuracy and traceability. By utilizing double-entry bookkeeping principles, the audit log 408 may enable reconciliation, compliance, and financial reporting for energy operations. The audit log 408 may be adapted to record energy data including energy-related transactions and/or associated metadata. The audit log 408 may further be adapted to record energy provenance data such as a type of energy, a source of energy, a destination of energy, energy attributes such as a green energy classification, a brown energy classification, a grey energy classification, and so forth.

The audit log 408 may further be configured to maintain a chain of custody for the energy-related transactions, according to at least one embodiment of the present invention. The audit log 408 may further be configured to maintain a chain of custody for the energy-related transactions in the data center environment. The chain of custody may include a chronological record of energy flow, documenting the origin, intermediate steps, and final allocation of energy within the data center. For instance, the audit log 408 may track energy sourced from renewable energy sources like solar panels or wind turbines, its intermediate storage in batteries or other energy storage devices, and/or its subsequent distribution to the one or more server components and/or the one or more virtual machines.

The chain of custody maintained by the audit log 408 may enable a traceability of the energy-related transactions for compliance purposes, validation of energy usage claims, auditing of energy transactions, and/or verification of adherence to regulatory and net metering standards.

The audit log 408 may be integrated with the EOM 402 to record real-time updates to the custody records, and reflect any dynamic aggregation, disaggregation, or reallocation of the energy resources across the data center environment.

According to at least one embodiment of the present invention, the energy pricing engine 410 may be configured to reconcile the energy data corresponding to the one or more IDERs in compliance with the one or more net metering standards.

The energy pricing engine 410 may be responsible for setting and updating energy prices in real time by analyzing a supply and/or demand of energy based on the fetched workload data corresponding to the IDERs. The energy pricing engine 410 may be configured to quantify market conditions to enable dynamic adjustments in the energy prices.

According to at least one embodiment of the present invention, the trading engine 412 may be configured to execute the energy-related transactions among the one or more data centers, the power grids, the microgrids, and so forth. The trading engine 412 may be configured to facilitate buying, selling, and/or exchange of the energy assets in the data center environment. In an embodiment of the present invention, the trading engine 412 may be configured to perform the buying, the selling, and/or the exchange of the energy assets within a tokenized ecosystem. In the tokenized ecosystem, the energy-backed tokens may correspond to the energy assets associated with the one or more IDERs and/or one or more VPPs.

In an embodiment of the present invention, the trading engine 412 may be configured to perform trading operations based on the one or more data analysis products generated by the EOM 402. The trading engine 412 may further be configured to support real-time energy-related transactions by matching energy supply with energy demand to enable an effective and/or efficient allocation of the energy resources across the data center environment.

In some embodiments of the present invention, the trading engine 412 may further be configured to utilize a decentralized ledger for recording the energy-related transactions into the charts of accounts 406. The decentralized ledger may enable transparency, immutability, and/or security of the recorded energy-related transactions by maintaining a distributed and tamper-proof log of all energy trades. The decentralized ledger may also be configured to integrate with decentralized finance (De-Fi) systems, which refer to blockchain-based financial technologies designed to eliminate intermediaries and provide automated, transparent, and/or permissionless financial services.

According to at least one embodiment of the present invention, the energy management system 400 may further include a tokenization platform 414. The tokenization platform 414 may be adapted for creation, management, and/or trading of the energy-backed tokens. The tokenization platform 414 may be adapted to facilitate a secure and efficient transaction of the energy assets. The tokenization platform 414 may be configured to enable the minting of the energy-backed tokens when surplus energy may be available, according to an embodiment of the present invention. The tokenization platform 414 may be configured to enable the burning of the energy-backed tokens when the energy may be consumed by the one or more IDERs and/or the VPPs.

For example, when a data center experiences surplus energy production from its solar panels or wind turbines connected to the IDERs, the tokenization platform 414 may be configured to mint the energy-backed tokens. The energy-backed tokens may be configured to represent the surplus energy and may be traded and/or stored for future use. In such a scenario, the energy-backed tokens may be minted based on the amount of the surplus energy produced and that may be quantified by the energy management system 400. Conversely, when the energy demand increases within the data center, such as when additional server components may be brought online and/or additional energy from the IDERs may be required to meet operational needs of the data center, the tokenization platform 414 may be configured to initiate the burning of the energy-backed tokens. The burning of the energy-backed tokens may represent a consumption and/or depletion of the energy. For instance, if 100 kWh of the energy is consumed by a microgrid associated to the data center, the equivalent energy-backed tokens may be burned to align the energy-backed tokens with an actual energy usage.

The tokenization platform 414 may be adapted to enable an accurate representation and/or tracking of the energy-related transactions through the energy-backed tokens. The tokenization platform 414 may be configured to perform real-time operations and/or scalability in energy distribution with in the data center environment.

The tokenization platform 414 may include a token engine 416 and a reserve manager 418, according to at least one embodiment of the present invention.

According to at least one embodiment of the present invention, the token engine 416 may be configured to issue the energy-backed tokens that may correspond to the energy assets of the one or more data centers (e.g., data centers 102). The token engine 416 may further be configured to maintain an alignment with real-time energy production, consumption, and/or trading activities.

According to at least one embodiment of the present invention, the reserve manager 418 may be adapted to oversee the management of fiat currency reserves associated with the energy-backed tokens transactions. The reserve manager 418 may be configured to maintain liquidity by tracking and maintaining the balance of the fiat currency available for redemption of the energy-backed tokens. The reserve manager 418 may further be configured to facilitate conversion of the energy-backed tokens into the fiat currency to enable financial operations within the tokenized energy ecosystem.

For example, if a data center experiences a period of the surplus energy, such as when renewable energy sources like solar panels or wind turbines connected to the IDERs 312a-312m may be producing more energy than is needed for operations, the token engine 416 may issue the energy-backed tokens corresponding to the excess energy.

If, for instance, 100 kWh of the surplus energy may be generated, the token engine 416 may issue 100 tokens such as each token representing 1 kWh of energy. As the surplus energy may be consumed and/or traded within the data center environment, the issued energy-backed tokens may be tracked in real-time by the token engine 416, maintaining an alignment with the energy production and consumption activities. Further, the reserve manager 418 may be configured to be involved if an administrator or a user wishes to redeem the issued energy-backed tokens for the fiat currency.

For example, if the issued energy-backed tokens may be traded for cash or redeemed within the energy management system 400, the reserve manager 418 may enable a liquidity of reserves of the fiat currency by converting the redeemed energy-backed tokens into the fiat currency.

The energy management system 400 may further include an analysis engine 420, a reporting engine 422, and an application programming interface 424.

According to at least one embodiment of the present invention, the analysis engine 420 may be configured to process and/or evaluate the energy data such as energy usage, transactions, system performance, and so forth. The analysis engine 420 may be configured to generate actionable insights, such as optimization recommendations, by analyzing telemetry and workload data. Optimization recommendations may include recommendations with respect to system parameters. Optimal parameter values may correspond to maximums, minimums, and/or combinations thereof, in accordance with operational goals. Alternatively, or in addition, optimal parameter values may correspond to non-extreme values that represent optimal trade-offs between competing goals. The analysis engine 420 may be adapted to support informed decision-making within the data center environment.

For example, the analysis engine 420 may be utilized by a data center operator and/or the administrator for the benefit of the energy optimization within the data center. In case, an energy consumption within the data center may be higher during peak operational hours. The analysis engine 420, after analyzing the fetched telemetry and the fetched workload data by the EOM 402, may be configured to generate insights indicating that shifting certain non-critical workloads to off-peak hours that may further reduce energy usage during the peak times. This actionable insight may allow the data center operator and/or the administrator to adjust a workload of some or more of the server components to optimize the energy consumption.

According to at least one embodiment of the present invention, the reporting engine 422 may be configured to generate reports based on energy-allied activities, and/or energy optimization metrics associated with the VPPs.

The reporting engine 422 may be adapted to generate detailed reports on energy and the energy-backed tokens-related activities. The reporting engine 422 may be configured to provide insights into transactions, energy usage, the energy-backed tokens issuance, compliance with regulatory standards, and so forth. The reporting engine 422 may be adapted to support transparency and/or accountability by delivering analytics and documentation tailored to the needs of stakeholders, such as regulators, investors, and energy market participants. The application programming interface 424 may provide a secure and extensible interface for external systems and users to interact with the energy management system 400 and the tokenization platform 414.

According to at least one embodiment of the present invention, the application programming interface 424 may enable access to functionalities such as transaction processing, reporting, and management of the energy-backed tokens while ensuring compliance with privacy and security standards. The application programming interface 424 may facilitate integration with third-party applications and/or services.

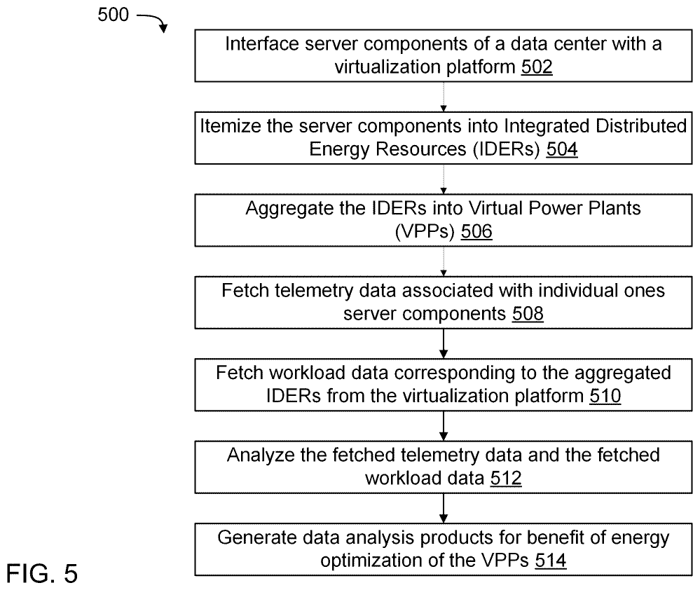

FIGS. 5-7 present illustrative one or more processes 500-700 for operating the computing environment 100 in accordance with at least one embodiment of the present invention. It is to be understood that the processes 500-700, as illustrated in the FIGS. 5-7, may be described in accordance with at least one embodiment of the present invention without direct reference to specific numerals of the components depicted corresponding to the computing environment 100. The omission of specific numerals for components in describing the processes 500-700 may not limit the scope of the invention, and the processes 500-700 may be implemented using any suitable configuration or arrangement of the components described in the computing environment 100.

The one or more processes 500-700 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any suitable number of the described blocks may be combined in any suitable order and/or in parallel to implement the process.

FIG. 5 depicts an exemplary process 500 of mapping the VPPs to physical data center energy resources, in accordance with at least one embodiment of the present invention.

At block 502, the energy management system may be configured to enable interfacing of the server components corresponding to the physical data center energy resources with the virtualization platform.

At block 504, the energy management system may be configured to itemize the server components into the IDERs using the virtualization platform.

At block 506, the energy management system may be configured to aggregate the IDERs into the VPPs.

At block 508, the energy management system may be configured to fetch the telemetry data that may be associated with the one or more server components using the EOM.

Next, at block 510, the energy management system may be configured to fetch the workload data corresponding to the one or more aggregated IDERs using the EOM.

Further, at block 512, the energy management system may be configured to enable the analysis of the fetched telemetry data and the fetched workload data using the EOM.

At block 514, the energy management system may be configured to generate the one or more data analysis products for the benefit of energy optimization of the VPPs.

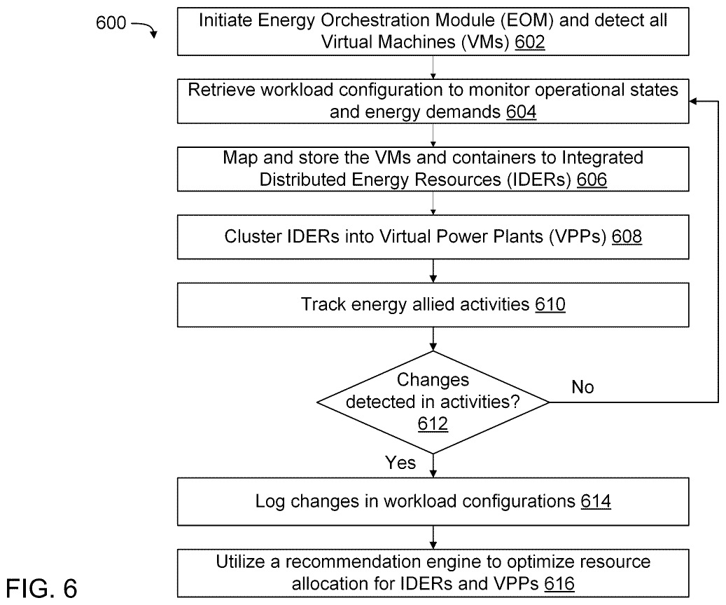

FIG. 6 depicts an exemplary process 600 of mapping the VPPs to virtual data center energy resources, in accordance with at least one embodiment of the present invention.

At block 602, the energy management system may be configured to detect the one or more virtual machines by initiating the EOM. The energy management system may further be configured to enable interaction of the EOM with the virtualization platform.

At block 604, the energy management system may be configured to retrieve workload configurations of the one or more virtual machines to monitor operational states and/or energy demand of the one or more virtual machines and/or the one or more software containers.

At block 606, the energy management system may be configured to map the one or more virtual machines and the one or more software containers to the one or more IDERs based on the energy usage profile for storing the mappings in the virtualization database.

At block 608, the energy management system may be configured to cluster the one or more IDERs into the one or more VPPs using the virtualization platform.

At block 610, the energy management system may be configured to track the energy-allied activities for the one or more virtual machines and the one or more software containers.

At block 612, the energy management system may be configured to check if changes in the energy-allied activities may be detected, then the process 600 may proceed to a block 614. Else, the process 600 may revert to the block 604.

At block 614, the energy management system may be configured to log the changes in the energy-allied activities. The energy management system may further be configured to determine the workload configurations and/or the time-shifting energy consumption.

At block 616, the energy management system may be configured to provide the one or more data analysis products for the benefit of the optimization of resource allocation for the IDERs and/or the VPPs.

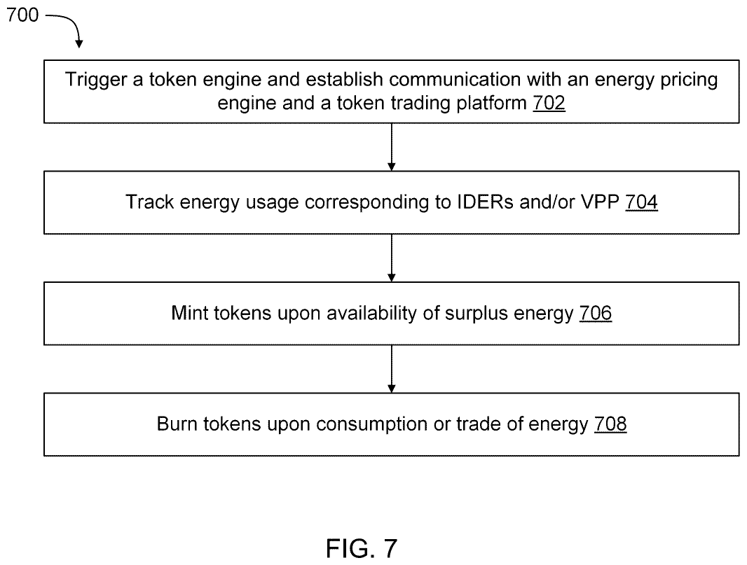

FIG. 7 depicts an exemplary process 700 of tokenization, in accordance with at least one embodiment of the present invention.

At block 702, the energy management system may be configured to trigger the token engine. The energy management system may establish a communication among the token engine, the energy pricing engine, and the trading engine.

At block 704, the energy management system may be configured to track the energy usage corresponding to the one or more IDERs and/or the one or more VPPs.

At block 706, the energy management system may be configured to mint the energy-backed tokens for representation of the energy when the surplus energy may be available.

At block 708, the energy management system may be configured to burn the energy-backed tokens when the energy may be consumed by the IDERs and/or the VPPs. According to an embodiment of the present invention, a value of the energy-backed tokens may be dynamically adjusted based on prevailing energy prices and demand fluctuations. The trading of the energy-backed tokens may be facilitated by a trading engine, with all transactions securely recorded by using one or more Decentralized Finance (DeFi) techniques.

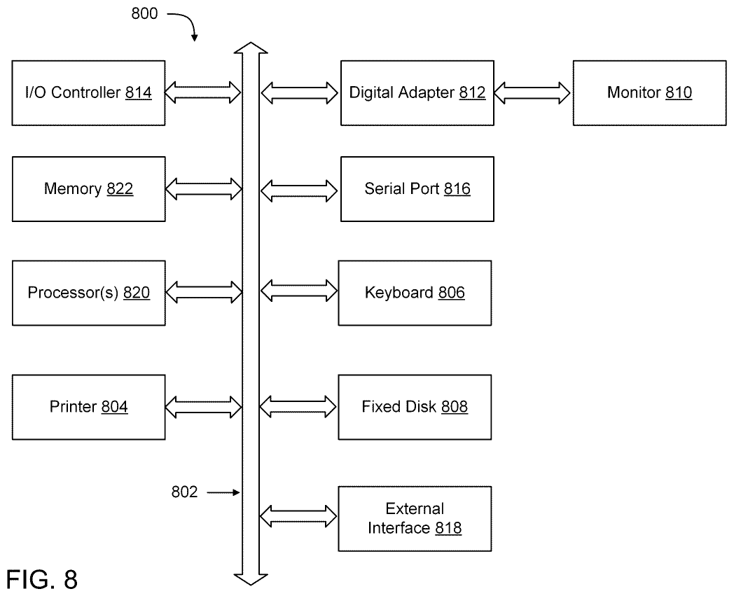

FIG. 8 depicts a schematic diagram illustrating aspects of an example computer, in accordance with at least one embodiment of the present invention. In accordance with at least some embodiments, the system, apparatus, methods, processes, and/or operations for message coding may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system.

As an example, the FIG. 8 depicts aspects of elements that may be present in a computer device and/or system 800 configured to implement a method and/or process in accordance with some embodiments of the present invention. The subsystems shown in FIG. 8 are interconnected via a system bus 802. Additional subsystems such as a printer 804, a keyboard 806, a fixed disk 808, a monitor 810, which is coupled with a display adapter 812. Peripherals and input/output (I/O) devices, which couple with an I/O controller 814, can be connected to the computer system by any number of means known in the art, such as a serial port 816. For example, the serial port 816 or an external interface 818 can be utilized to connect the computer device 800 to further devices and/or systems not shown in FIG. 8 including a wide area network such as the Internet, a mouse input device, and/or a scanner. The interconnection via the system bus 802 allows one or more processors 820 to communicate with each subsystem and to control the execution of instructions that may be stored in a system memory 822 and/or the fixed disk 808, as well as the exchange of information between subsystems. The system memory 822 and/or the fixed disk 808 may embody a tangible computer-readable medium.

It should be understood that the present invention as described above can be implemented in the form of control logic using computer software in a modular or integrated manner. Alternatively, or in addition, embodiments of the invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes, or functions described in this application may be implemented as software code to be executed by a processor using any suitable computer language such as, for example, Java, C++, or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub combinations are useful and may be employed without reference to other features and sub combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An energy management system for integration of one or more data centres, comprising:
at least one virtualization platform configured to interface with a plurality of server components, wherein the individual ones of the interfaced plurality of server components are itemized into one or more integrated distributed energy resources (IDERs);
at least one energy orchestration module (EOM) communicatively coupled with the at least one virtualization platform, wherein the at least one EOM is configured to:
aggregate the one or more IDERs into at least one virtual power plant (VPP);
fetch telemetry data associated with the individual ones of the plurality of server components;
fetch workload data corresponding to individual ones of the aggregated IDERs from the at least one virtualization platform;
analyze one or more of the fetched telemetry data and the fetched workload data; and
generate one or more data analysis products for energy optimization of the at least one VPP based at least in part on the analysis of the one or more of the fetched telemetry data and the fetched workload data.

2. The energy management system of claim 1, wherein the individual ones of the plurality of server components comprises at least one power transaction unit (PTU) configured for monitoring the telemetry data of the individual ones of the plurality of server components.

3. The energy management system of claim 1, wherein the individual ones of the plurality of server components are integrated to at least one power distribution unit (PDU) configured for distributing power from a centralized power backbone to the individual ones of the plurality of server components.

4. The energy management system of claim 1, wherein the at least one virtualization platform is further configured to itemize the individual ones of the interfaced plurality of server components at least in part by:
creating, from virtual server components, one or more virtual machines, one or more software containers, or a combination thereof; and
mapping the one or more virtual machines, the one or more software containers to the one or more IDERs within the at least one VPP.

5. The energy management system of claim 4, wherein the at least one virtualization platform is further configured to:
track energy-allied activity of one or more of the one or more virtual machines, and the one more software containers; and
associate the one or more tracked software containers corresponding with the one or more IDERs and the at least one VPP.

6. The energy management system of claim 4, wherein the at least one EOM is configured to fetch the mapping of one or more virtual machines, one more software containers to the one or more IDERs within the at least one VPP from the at least one virtualization platform.

7. The energy management system of claim 1, wherein the at least one EOM is further configured to:
receive pre-defined mappings of the one or more virtual machines and one or more VPPs from an external source; and
store the received mappings in a parallel configuration within a virtualization database.

8. The energy management system of claim 1, wherein the at least one EOM is further configured to dynamically adjust power allocation to part of the one or more aggregated IDERs based on the generated one or more data analysis products.

9. The energy management system of claim 1, wherein the at least one EOM is configured to utilize at least one energy storage device associated with the at least one VPP for time-shifting energy consumption.

10. The energy management system of claim 1, wherein the at least one EOM is configured to reconcile energy data corresponding to a part of the aggregated IDERs in compliance with at least one net metering standard.

11. The energy management system of claim 1, comprising at least one trading engine configured to manage one or more of a creation, a validation, and a trading of energy-backed tokens corresponding to energy assets associated with the at least one VPP.

12. The energy management system of claim 1, comprising at least one reporting engine configured to generate one or more reports based on energy-allied activities associated to the at least one Virtual Power Plant (VPP).

13. A method for energy orchestration in a data centre environment, comprising:
interfacing, via at least one virtualization platform, with a plurality of server components, wherein the individual ones of the interfaced server components are itemized into one or more integrated distributed energy resources (IDERs);
aggregating, by at least one energy orchestration module (EOM), the one or more IDERs into at least one virtual power plant (VPP);
fetching telemetry data associated with the individual ones of the plurality of server components via the at least one EOM;
fetching workload data corresponding to individual ones of the aggregated IDERs from the at least one virtualization platform via the at least one EOM;
analysing one or more of the fetched telemetry data and the fetched workload data to generate insights into energy utilization; and
generating one or more data analysis products for optimizing energy allocation within the at least one VPP based at least in part on the analysing of the one or more of the fetched telemetry data and the fetched workload data.

14. The method of claim 13, further comprising dynamically adjusting, via the at least one EOM, power allocation to part of the one or more aggregated IDERs based on the generated data analysis products.

15. The method of claim 13, further comprising reconciling energy data corresponding to a part of the aggregated IDERs in compliance with at least one net metering standard.

16. The method of claim 13, further comprising utilizing at least one energy storage device associated to the at least one VPP for time-shifting energy consumption.

17. The method of claim 13, further comprising generating one or more reports detailing energy-allied activities and energy optimization metrics for the at least one VPP via a reporting engine.

18. The method of claim 13, further comprising managing one or more of a creation, a validation, and a trading of energy-backed tokens corresponding to energy assets associated with the at least one VPP via a trading engine.

19. One or more computer-readable media collectively storing instructions that, when executed by one or more processors, collectively cause one or more computing devices to, at least:
interface, via at least one virtualization platform, with a plurality of server components, wherein the individual ones of the interfaced server components are itemized into one or more integrated distributed energy resources (IDERs);
aggregate, by at least one energy orchestration module (EOM), the one or more IDERs into at least one virtual power plant (VPP);
fetch telemetry data associated with the individual ones of the plurality of server components via the at least one EOM;
fetch workload data corresponding to individual ones of the aggregated IDERs from the at least one virtualization platform via the at least one EOM;
analyse one or more of the fetched telemetry data and the fetched workload data to generate insights into energy utilization; and
generate one or more data analysis products for optimizing energy allocation within the at least one VPP based at least in part on the analysis of the one or more of the fetched telemetry data and the fetched workload data.

20. The non-transitory computer-readable medium of claim 19, wherein the instructions further cause the computing device to utilize at least one energy storage device associated with the at least one VPP to time-shift energy consumption.
